(19) United States
(12) Patent Application Publication
(10) Pub. No.: US 2025/0201940 A1
(43) Pub. Date: Jun. 19, 2025

(54) Battery Management System Architecture

(71) Applicant: Lithium Power, Inc., San Jose, CA (US)

(72) Inventors: MingHung Ho, Milpitas, CA (US); Wilson Chan, San Jose, CA (US)

(21) Appl. No.: 18/543,295

(22) Filed: Dec. 18, 2023

(51) Int. Cl. H01M 10/42

(52) U.S. Cl. CPC H01M 10/425; H01M 10/4207; H01M 2010/4278

(57) ABSTRACT

A system for automatically assigning identification codes to batteries connected in series by using a single address line and upgrading boot image for the connected batteries. A first battery receives a first identification code from one incoming address line and saves the first identification code. A second identification code is generated by the first battery and the first battery sends the second identification code to a second battery through a second address line. The upgrade boot image is segmented and multi-casted to the connected batteries.

### FIELD OF THE INVENTION

The present invention relates to battery and more specifically to battery system architecture.

### BACKGROUND OF THE INVENTION

Battery usage is becoming increasingly common and popular in all applications. As the battery usage spreads through all different parts of daily life, it is becoming common to use a battery bank composed of multiple battery cells and efficiently addressing and controlling each battery cell becomes of paramount importance.

This invention teaches an architecture for a battery bank that enables easy and efficient way to address each battery cell and its management system.

### SUMMARY OF THE INVENTION

In one embodiment, the invention is a system for connecting a plurality of batteries. The system comprises a host server and a plurality of batteries connected to the host server. A first battery receives a single pulse on a first address line from the host server and the first battery sends a two-pulse signal to a second battery through a second address line, a first identification code (ID) is received by the first battery through the first address line, a second ID is generated by the first battery based on the first ID with an increment and sent to the second battery through the second address line.

In another embodiment, the invention is a method for assigning identification codes to a plurality of batteries. The method comprises connecting the plurality of batteries in series, sending a first identification code on a sin to a first battery, generating a second identification code by the first battery, and sending the second identification code to a second battery.

Yet in an alternate embodiment, the invention is a method for upgrading boot images for batteries connected in series. The method comprises segmenting a boot image into multiple segments, multi-casting multiple segments sequentially on a CAN bus to the batteries connected in series, multi-casting a check code for the boot image to the batteries, and uni-casting a requested segment to a requesting battery after receiving a request from the requesting battery.

The present system and methods are therefore advantageous as they enable easy and efficient way to automatically generating identification codes to a plurality of batteries connected together. Other advantages and features of the present invention will become apparent after review of the hereinafter set forth Brief Description of the Drawings, Detailed Description of the Invention, and the Claims.

### DESCRIPTION OF THE DRAWINGS

Features and advantages of embodiments of the invention will become apparent as the following detailed description proceeds, and upon reference to the drawings, where like numerals depict like elements, and in which:

FIG. 1 is a diagram 100 of a battery management system of the present invention.

FIG. 2 is a schema 200 showing a topology with an Ethernet switch.

FIG. 3 is a connection between the host and the batteries may also be through Ethernet cable running half duplex mode.

FIG. 4 is a connection between the host and the batteries can be enhanced through use of a tree topology with an Ethernet hub.

FIG. 5 is a flow chart 500 of an auto identification process for batteries connected to a host.

FIG. 6 is a flow chart 600 for an authentication process with possible topology change.

FIG. 7 illustrates a boot image upgrade process 700 through multi-cast method.

FIG. 8 illustrates a single boot image upgrade process 800 through a sequential upgrade method.

FIG. 9 is a flow chart 900 for upgrading boot image.

### DETAIL DESCRIPTION OF THE INVENTION

In this description, the term “application” as used herein is intended to encompass executable and non-executable software files, raw data, aggregated data, patches, and other code segments. The term “exemplary” is meant only as an example, and does not indicate any preference for the embodiment or elements described. Further, like numerals refer to like elements throughout the several views, and the articles “a” and “the” includes plural references, unless otherwise specified in the description. The terms lithium-based battery, lithium-ion battery, lithium-iron-phosphate battery, and lithium battery are used interchangeably and “battery” and “battery pack” are used interchangeably. The lithium battery in this specification refers to any type of lithium battery.

In an overview, the present invention provides a battery management system and method for management of a battery bank composed of multiple batteries connected in series, each battery has multiple battery cells and a battery management system. The system allows management of each individual battery, enabling each individual battery to be addressed individually. Each battery also has a CAN (controller area network) bus controller, Ethernet network connection, and an input/output (IO) port. The address lines in the control plan cable are connected in daisy chain wiring scheme through the IO ports. Each individual battery can be accessed by the host server and the host server can sends commands and data to each individual battery through CAN bus network or Ethernet network. Firmware upgrade can also be performed by sending upgrade command from the host server.

The control plan cable has one address line and two data network connections. One is the CAN bus network and the other is the Ethernet network. It provides user-friendly control configuration to identify each battery ID and multiple network connections cable for performance and redundancy purposes in one single physical cabling system. The invention uses auto-discovery feature to identify each BMS with no human intervention. It also can also generate a sequential CAN bus ID and will be in the ascending order so that operator can co-related CAN bus ID to a physical position. Also a LED indicator can be used to identify the physical position from outside. It also provides multiple connection methods for customer's preference to collect information.

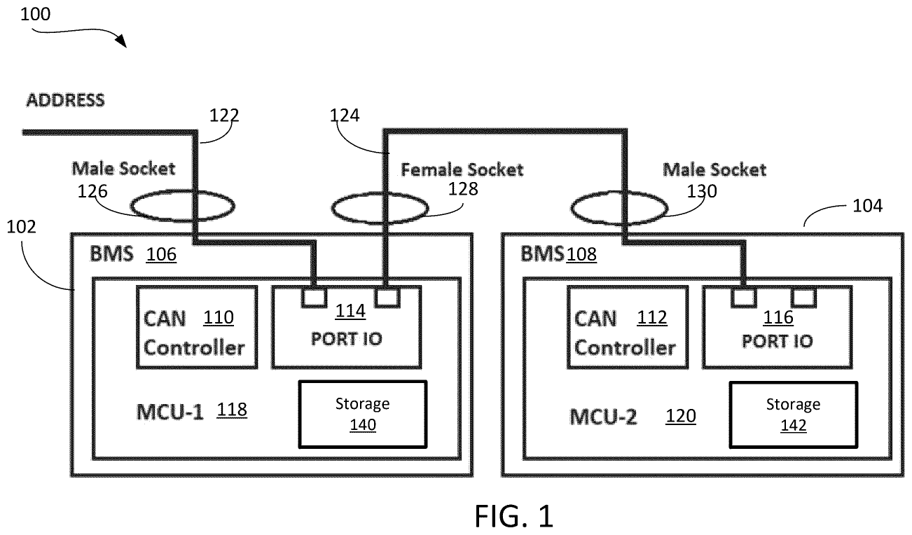

FIG. 1 is a diagram 100 of a battery management system of the present invention. One connection cable is used to connect battery 102 to the host server and another connection cable is used to connect battery 102 to battery 104. Each battery has its own battery management system (BMS) 106, 108 that includes a micro controller (MCU) 118, 120, a controller area network (CAN) bus controller 110, 112, and an IO port 114, 116. Each BMS also has a storage unit 140, 142, where machine instructions are stored. The machine instructions, when executed by the micro controller, control the operation of the BMS. The IO port 114, 116 has a female socket and a male socket and each connection cable also has a male socket 126, 130 on one end and a female socket 128 on other end. The male connector (socket) of the connection cable is inserted into the female socket and the address line goes into the incoming IO port and the female connector of the connection cable is connected to the male socket and the address line goes into the outgoing IO port. The connection cable has an address line 122 that enters into an input port on an IO port 114. The address line 124 of other connection cable exits from an output port on the IP port 114 and enters into the input port for the IP port 116.

When setting the identification of batteries connected in series, the host server assign an identification code (ID) to the first connected battery 102, for example ID 1, by setting one strobe on a single address line 122. The MCU-1 118 receives the ID from the address line and sends two strobes onto the address 124 to the next battery 104. The MCU-2 120 will receive two strobes from the address line 124 and sets its ID to 2. The scheme is repeated to all other batteries connected together and this scheme allows identification of every battery through a single address line. With proper identification, each battery will be able to receive data from the host computer, data such as image upgrade and configuration data, and each battery will also be able to send data, such as event log, back to the host computer.

The BMS on each battery has a female and a male sockets as described previously. Each socket may have 8 pins (M12 A coded 8-pin socket) and only one pin is needed for the address line. The CAN bus connection requires 2 pins, CAN_H and CAN_L. When the Ethernet is used for the communication between the batteries, the Ethernet connection requires 4 pins. One pin is used as ground pin for the BMS and other 4 pins are reserved.

One common pin assignment for the Ethernet connection is as follows.
1 pin for address line
2 pins for CAN bus connection: CAN_H and CAN_L
4 pins for Ethernet connection: Transmit Positive (TX+), Transmit Negative (TX−), Receive Positive (Rx+), Received Negative (Rx−), and
1 pin for ground pin

The address line is required for Ethernet running on a control plan or a power plan; it is used for identification and auto-discovery of a unique ID on the BMS. The ID is assigned sequentially to match the BMS's physical location and the ID usually starts from 1 and increase by one for the next BMS.

When the Ethernet is used for connecting the BMS, the Ethernet/IP runs in parallel with CAN bus traffic. Cabling will be similar depending on what type of duplex traffic configuration. If used with a switch device then a y-cabling is required to connect to a switch. For Ethernet in the half duplex mode, there are no devices required for BMS connected in parallel. If devices other than the host PC are connected, then a hub is required.

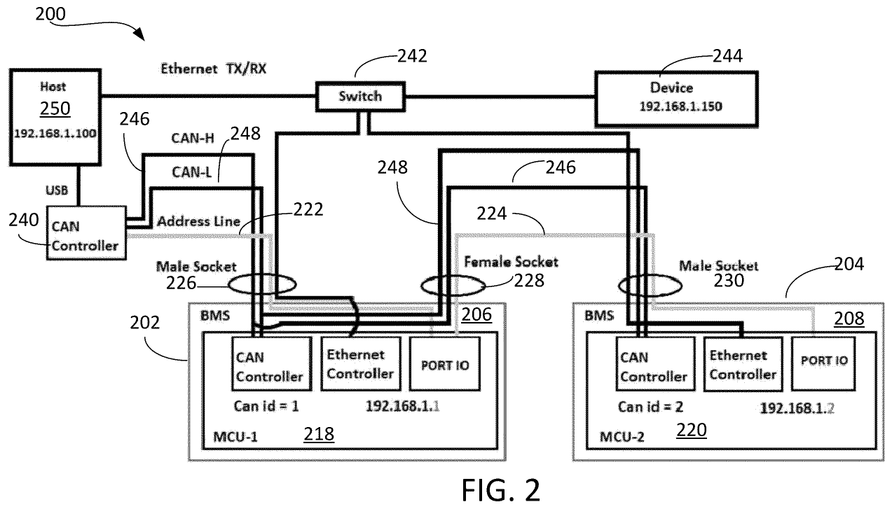

FIG. 2 is a schema 200 showing a topology with an Ethernet switch. The host 250 is connected to a switch 242 through an Ethernet cable and the switch may also be connected to another device 244. The host 250 communicates through a USB connection with a CAN controller 240. The CAN controller uses CAN-H and CAN-L to communicate with batteries 202, 204. The connection between the CAN controller and the batteries 202, 204 are in parallel. The address line 222 connects the CAN controller 240 to an input port on the BMS 206 and another address lines 224 exits from an output port on the BMS 206 and destines to an input port on the BMS 208. This arrangement enables the BMS 206 to have “1” as CAN ID and the BMS 208 to have “2” as CAN ID. This topology can run Ethernet with 10/100 M in full duplex mode. It requires a special proprietary Y-cable. The advantage of this connection is that it has better performance in the full duplex mode. The downside is that cabling might not be backward compatible.

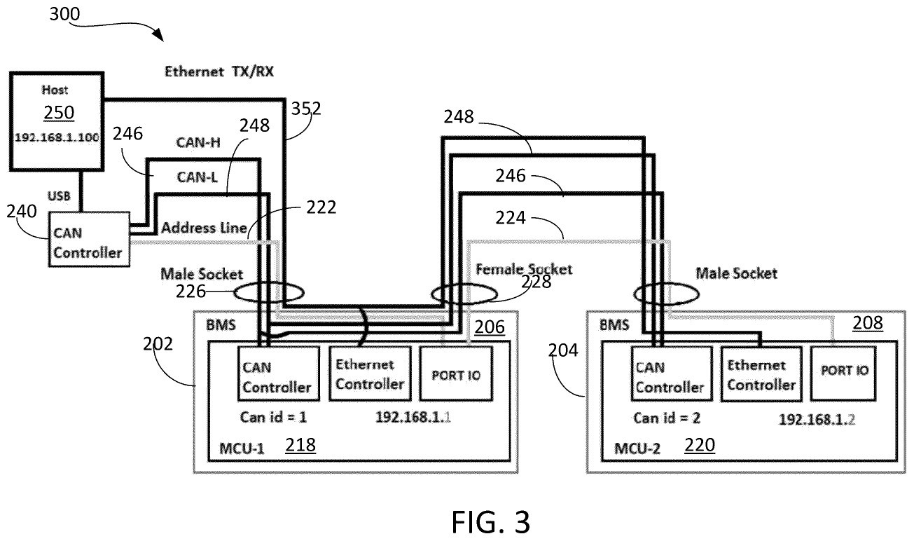

The connection between the host and the batteries may also be through Ethernet cable running half duplex mode as shown in FIG. 3. The host 250 is connected through an Ethernet cable 352 to batteries 202, 204. The BMS 206, 208 on each battery has an Ethernet controller. The host 250 is also connected to a CAN controller 240 through an USB connection. The male socket 226 of the Ethernet cable is plugged into the battery 202 and another Ethernet cable connects from a female socket 228 to the next battery 204. This topology is similar to the connection commonly used to connect the batteries and it can co-exist with a CAN bus network with the same cabling system. The shortcoming of this topology is that the bandwidth is in half compared with the full duplex mode. However, the bandwidth that is 10/100M bits/s is better than CAN bus network, chi is roughly less than 1M bits/s.

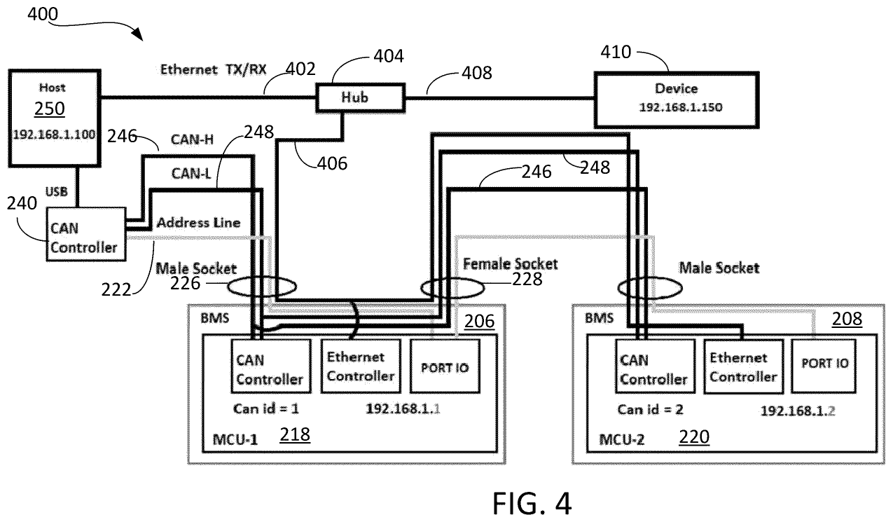

The connection between the host and the batteries can be enhanced through use of a tree topology with an Ethernet hub as shown in FIG. 4. The schema 400 is similar to the schema 200 except that switch 242 being replaced by an Ethernet hub 404. The schema 400 allows additional device to be added. It supports addition of a storage device to the network for IOT feature. Battery historical data can be saved to the devices as cloud service for future analysis.

The ID assignment is made easy as described above. The CAN bus ID for the first battery will be assigned to 1 through the address line auto discovery and the CAN bus ID for the second battery will be assigned to 2. This ID assignment method is applied to all connected batteries.

For batteries connected through Ethernet connection, the IP (Internet Protocol) address for the first CAN bus controller will be 192.168.1.1. The last digit of the IP address reflects the ID from the address line auto discovery. The IP address for the second CAN bus controller will be 192.168.1.2 following the same scheme. When IPv6 is used, the BMS can have the event and data uploaded to the Internet cloud once it has been set up properly. The batteries can also become IOT devices.

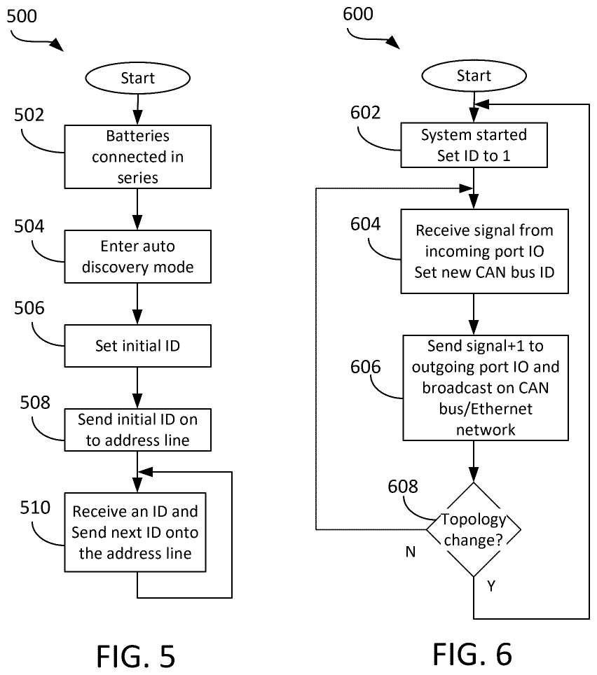

The system of the present invention enables easy access to the batteries connected in series, each battery is assigned a unique identification automatically. FIG. 5 is a flow chart 500 of an auto identification process for batteries connected to a host, step 502. When the host starts, it enters an auto discovery process to identify the connected batteries, step 504. The host sets an initial ID, step 506, and this ID is sent on the address line to the first connected battery, step 508. Usually this initial ID is set as “1” but other value may also be used. An initial strobe is sent over the address line to reflect the first ID. This strobe on the address line is received by the first battery, which interprets this strobe as the assigned ID. After setting the ID as “1,” the first battery sends another ID, with an increment from the received ID, over the outgoing address line to the next connected battery, step 510. This process is repeated for all the connected batteries. Generally the increment is set to “1,” however other increment values may also be considered. This ID is interpreted as the CAN bus ID assigned to each connected battery.

The flow chart 600 of FIG. 6 depicts an auto start process with topology change detection. The system starts with the first ID for CAN bus device set to 1, step 602. This ID is sent over the address line and received by the first connected device, which receives and sets its CAN bus ID to 1, step 604. This device then sends another ID, which is the received ID increased by 1, onto the outgoing port IO. This new ID is broadcasted on the CAN bus or over the Ethernet network, step 606. This process of setting ID according to the received signal and increasing the ID and sending to the next connected device repeats until all devices are discovered. When a topology change is detected, step 608, the system restarts the process by setting the ID to 1, step 602.

After the auto discovery process, the host may send a broadcast command that asks each BMS from the connected batteries to return its CAN bus ID. After receiving the responses from all the BMS (batteries), the host will learn the quantity of the connected batteries and also the maximum CAN bus ID. Each BMS may also broadcasts its CAN bus ID through a “keep alive” command periodically to indicate its sanity.

When the host is connected to the batteries through an Ethernet connection, terminators are plugged into the output port of the IO port to avoid signal from rebounding back to the network. The use of the terminator is also applicable to half-duplex bus topology in the Ethernet connection.

Each of the host and the BMS' described above has a controller and a data storage unit for storing computer executable instructions. The controller executes these instructions to perform the functions described above.

Signal will be sent out every 30 seconds on the address line and the ID of connected batteries will be updated in case the topology has changed due to re-cabling. The host server will detect topology change when it senses the cable connecting the batteries is disconnected and the MCUs on the batteries will get interrupted signal in the IO port, which signals the change in the topology. The host server may also issue a command to the MCUs to re-scan the network topology.

The BMS of each battery has a LED display on the outside of the battery to show the ID once the ID is generating from interconnecting of the control plan cable. Otherwise, ID is defaulted to 1. CAN bus network or Ethernet network will be based on unique IDs to form a unique address on each BMS. This LED feature is to increase the debuggability and serviceability of the system.

The following is a table depicting the relation between IDs and LED(s).

TABLE 1

| | LED | | | | | | | | | |
|---|---|---|---|---|---|---|---|---|---|---|
| CAN ID | L1 | L2 | L3 | L4 | L5 | L6 | L7 | L8 | L9 | L10 |
| 1 | | | | | | off | off | off | off | On |
| 2 | | | | | | off | off | off | On | off |
| 3 | | | | | | off | off | off | On | On |
| 4 | | | | | | off | off | On | off | off |
| 5 | | | | | | off | off | On | off | On |
| 6 | | | | | | off | off | On | Y | off |
| 7 | | | | | | off | off | On | On | On |
| 8 | | | | | | off | On | off | off | off |
| 9 | | | | | | off | On | off | off | On |
| 10 | | | | | | off | On | off | On | off |

In the context of FIGS. 5 and 6, the steps illustrated do not require or imply any particular order of actions. The actions may be executed in sequence or in parallel. The method may be implemented by executing a sequence of machine-readable instructions embedded in memory (storage unit) the MCUs or in the controller in the BMS. The instructions can reside in various types of signal-bearing or data storage unit.

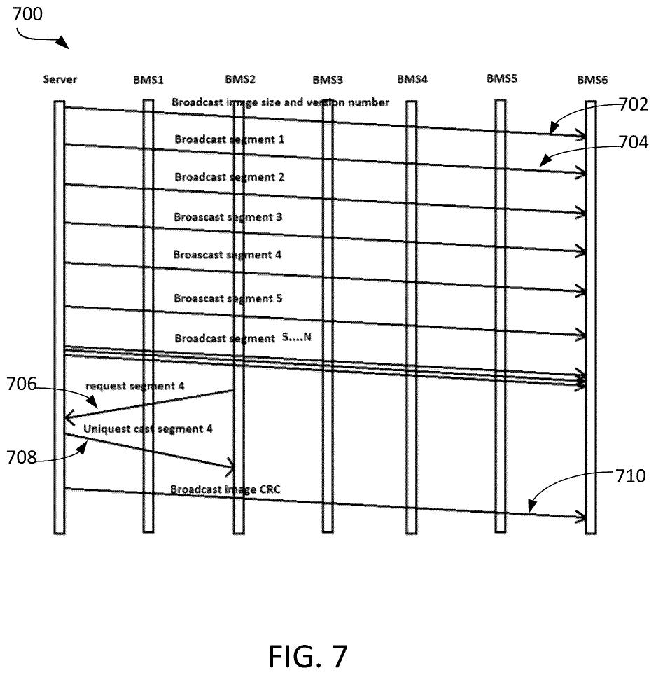

The architecture of the present invention is particularly suited for upgrading boot image for multiple BMS. This architecture supports both multi-cast and uni-cast methods. In the multi-cast method, the broadcasted data is available to all the connected BMS; in the uni-cast method the broadcasted data is destined for a particular BMS. FIG. 7 depicts a boot image upgrade using the multi-cast method. During the image upgrade, the boot image is broadcasted to all the BMS connected to the CAN bus network. The boot image information is first broadcasted to all the BMS, 702. Because of limit of data size during the transfer, the boot image may be broken (segmented) into multiple small segments and these segments are broadcasted sequentially. 704. Each BMS will receive the segments and re-assemble the boot image. If a received segment is corrupted, the BMS will send a request for re-transmission, 706, and the requested segment will be uni-casted to the requesting BMS, 708. The data checking algorithm such as cyclic redundancy check (CRC) method may be used for data integrity check and the CRC code will be broadcasted to all the BMS, 710. The received boot image will be written into the flash memory (storage device) after re-assembled.

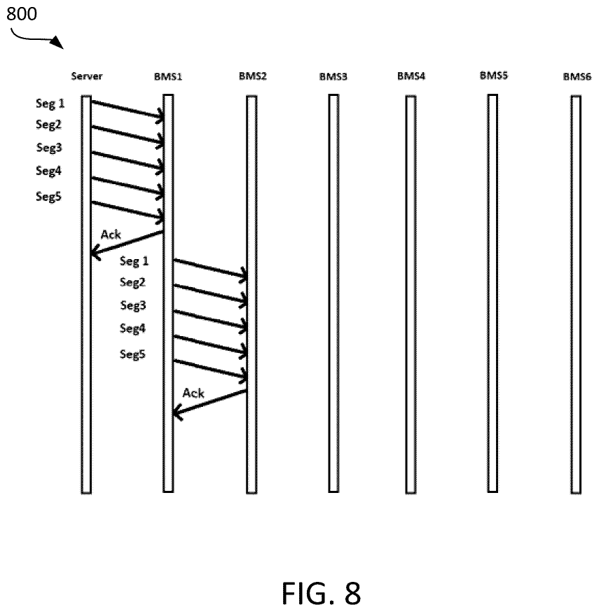

Alternatively, the boot image may also be uni-casted to a first BMS and this first receiving BMS will then broadcast the received boot image to the next BMS. This process repeats until all the connected BMS receive the new boot image as shown in FIG. 8.

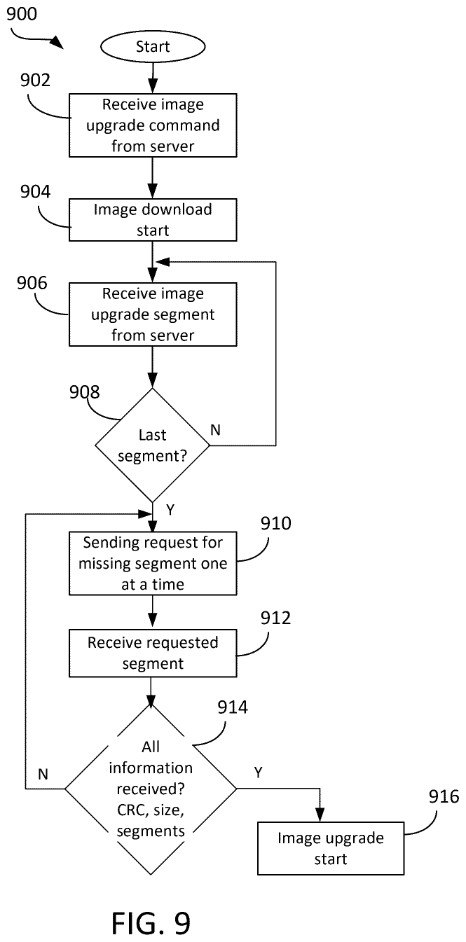

FIG. 9 is a flow chart 900 for upgrading boot image for the batteries connected in series. The server sends an image upgrade command to all the connected BMS, step 902, and the upgrade image download starts, step 904. The boot image may be broken into several segments if the size exceeds the allowable size. The segmented boot images are transmitted sequentially, and a checksum information is transmitted at the end. The segments of the upgrade boot image are received by all the connected BMS, step 906, and this process is repeated until the last segment, step 908. When the last segment is received, each BMS will check whether all segments have been received. If there is a segment is missing, a request for missing segment is sent by the BMS to the server, step 910. The missing segments are re-sent by the server and received by the BMS, step 912. The information on the new boot image, such as version and the size, is also transmitted. Each BMS checks whether all information, including CRC, the size, and the number of segments, have been received, step 914. Each receiving BMS will re-assemble the boot image and check for the data integrity, step 916. If any segment is missing or corrupted, then the BMS will send a re-transmit request and the server will repeat steps 910, 912.

For a boot image download, the maximum image size supported is 32K byte and the total file transfer size will be 4*N+image length+version number+CRC. Table 2 below illustrates a data transfer for image upgrade.

TABLE 2

| | Time | Length | Data |
|---|---|---|---|
| Version → | 6.031 | 8 | 95 |
| Size → | 6.041 | 8 | 96 |
| Data → | 6.058 | 8 | 97 |
| | 6.087 | 8 | 97 |
| | 6.156 | 8 | 97 |
| | 6.173 | 8 | 97 |
| | 6.210 | 8 | 97 |
| | 6.367 | 8 | 97 |
| | 6.422 | 8 | 97 |
| | 6.518 | 8 | 97 |
| | 6.596 | 8 | 97 |
| | 6.632 | 8 | 97 |
| | 6.713 | 8 | 97 |
| | 6.754 | 8 | 97 |
| | 6.826 | 8 | 97 |
| CRC → | 6.853 | 8 | 98 |

The upgrade command is 94 for image download and table 2 illustrates the data transfer for upgrading boot image. The transfer starts with version command, which is upgradeCmd+1=95 and image size command, which is upgradeCmd+2=96. It can be seen in the “Data” column the first data is “95” identifying the version of the upgrade boot image and the second data is “96” identifying the size of the upgrade boot image. The firmware data command is upgradeCmd+3=97 and the image upgrade data is broken into several segments as shown in table 2. At the end of transfer, a CRC is sent; the CRC command is upgradeCmd+4=98. Other commonly used commands not shown in table 2 include status command (upgradeCmd+5=99) and error command (upgradeCmd+6=100).

After the boot image is downloaded into the memory of the BMS through CAN Bus or other communication protocol, it can be written into one of the banks from the memory. Usually, it will be the bank that has the older version of the boot image. Once the boot image is programmed properly, the system to point to this bank for the next boot.

Before an image is written into the flash memory, it is a good practice to make sure that the bank flash is in a good condition for reading and writing. This can be done by writing pattern 0xFF into the flash memory bank and reading it back. If read out pattern matches what was written into the bank flash location, then the bank location will be marked as good condition and ready to use. The upgrade process is irreversible, if it fails then the system needs to roll back to the previous bank.

What is claimed is:

1. A system for connecting a plurality of batteries, comprising:
a host server; and
a plurality of batteries connected to the host server,
wherein a first battery receives a first address line from the host server and the first battery sends a second address to a second battery through a second address line, a first identification code (ID) is received by the first battery through the first address line, a second ID is generated by the first battery based on the first ID with an increment and sent to the second battery through the second address line.

2. The system of claim 1 further comprising at least one connection cable connecting the host server and the plurality of batteries.

3. The system of claim 2, wherein the at least one connection cable is an Ethernet cable.

4. The system of claim 2, wherein the at least one connection cable has on end with a male connector and one end with a female connector.

5. The system of claim 2, wherein the at least one connection cable has at least one address line.

6. The system of claim 1, wherein the first identification code is 1.

7. The system of claim 1, where in the increment is 1.

8. The system of claim 1, each battery in the plurality of batteries has CAN bus controller and the identification code received from the address line is assigned as the CAN bus controller identification code.

9. The system of claim 1, further comprising a LED display for displaying the ID.

10. A method for assigning identification codes to a plurality of batteries, comprising the steps of:
a. connecting the plurality of batteries in series;
b. sending a first identification code on an address line to a first battery;
c. generating a second identification code by the first battery; and
d. sending the second identification code to a second battery.

11. The method of claim 10, wherein generating the second identification code is done by incrementing the first identification code with a predefined value.

12. The method of claim 11, wherein the predefined value is 1.

13. The method of claim 10, wherein steps 2, 3, and 4 are repeated when a topology change indication is received.

14. A method for upgrading boot images for batteries connected in series, comprising:
segmenting a boot image into multiple segments;
multi-casting multiple segments sequentially on a CAN bus to the batteries connected in series;
multi-casting a check code for the boot image to the batteries; and
uni-casting a requested segment to a requesting battery after receiving a request from the requesting battery.

15. The method for upgrading boot image of claim 14, further comprising receiving acknowledgment from each of the connected batteries.

16. The method of upgrading boot image of claim 14, further comprising:
multi-casting version information of the boot image to the connected batteries; and
multi-casting size information of the boot image to the connected batteries.
